(19) United States
(12) Patent Application Publication
(10) Pub. No.: US 2017/0139575 A1
(43) Pub. Date: May 18, 2017

(54) DATA ENTERING METHOD AND TERMINAL

(71) Applicant: ZTE CORPORATION, Guangdong (CN)

(72) Inventor: Feixiong CHEN, Guangdong (CN)

(73) Assignee: ZTE CORPORATION, Guangdong (CN)

(21) Appl. No.: 15/312,817

(22) PCT Filed: Jul. 24, 2014
(86) PCT No.: PCT/CN2014/082952

§ 371 Date: Nov. 21, 2016

(30) Foreign Application Priority Data
May 21, 2014 (CN) 201410217374.9

(51) Int. Cl. G06F 3/0484; G06K 9/46; G06K 9/20; G06F 3/0488

(52) U.S. Cl. CPC G06F 3/04845; G06F 3/04842; G06F 3/04886; G06K 9/4604; G06F 3/04883; G06K 9/2081

(57) ABSTRACT

Disclosed are a data inputting method and terminal. The terminal includes: a processor; and a memory for storing instructions executable by the processor; wherein the processor is configured to: extract data information from a capturing object; identify an operation gesture of a user, and input the extracted data information into a target region according to an inputting manner corresponding to the identified operation gesture, wherein the inputting manner comprises an application program to be inputted and an input format.

### CROSS-REFERENCE TO RELATED APPLICATION

This application is the 371 application of PCT Application No. PCT/CN2014/082952, filed Jul. 24, 2014,which is based upon and claims priority to Chinese Patent Application No. 201410217374.9, filed May 21, 2014, the entire contents of which are incorporated herein by reference.

### TECHNICAL FIELD

The present disclosure relates to the field of communication, and particularly, to a method for inputting data and a terminal.

### BACKGROUND

At present, a display area of a screen of a handhold user terminal, such as a smart phone and a tablet computer (PAD), increases, this enables more information to be displayed. In addition, since such user terminals have high-capacity storage space and strong processing ability, the user terminals may achieve more and more functions like a microcomputer. Moreover, the expectation to the handhold terminal by the user becomes higher. For example, as to information which needs to be inputted by a keyboard conventionally, it is expected to input such information by a peripheral device of the user terminal with a certain data processing.

Conventionally, when the user needs to convert outside computer-unidentifiable information (such as information recorded on a billboard in a store, or information transferred to the user via picture by other user) into computer-identifiable information, he/she needs to manually input such information into the handhold terminal one by one via the keyboard of the user terminal, which is time-consuming and arduous, especially in the case that the amount of information needing to be inputted is large, the user will spend more time and mistakes are easily occurred by the manual input.

Although an OCR recognition can quickly acquire the computer-identifiable information, after such information is identified, it is also necessary for the user to paste the identified information to other application program. It is impossible to perform an automatic inputting, and the user experience is poor.

With respect to the above problems existing in manually inputting outside computer-unidentifiable information in the related art, no effective solution is proposed till now.

This section provides background information related to the present disclosure which is not necessarily prior art.

### SUMMARY

With respect to the problems of time and energy waste as well as low accuracy existing in manually inputting outside computer-unidentifiable information in the related art, the present disclosure provides a method for inputting data and a terminal for at least solving the above problems.

According to one aspect of the present disclosure, there is provided a terminal, including: a data capturing module configured to extract data information from a capturing object; a rapid inputting module configured to identify an operation gesture of a user, and input the extracted data information into a target region according to an inputting manner corresponding to the identified operation gesture, wherein the inputting manner includes an application program to be inputted and an input format.

Optionally, the data capturing module includes: an interaction module configured to detect a region selecting operation with respect to a picture displayed on a screen of the terminal so as to acquire the capturing object; an image processing module configured to perform an image processing on the capturing object to obtain a valid picture region; and a first identification module configured to identify the valid picture region so as to extract the data information.

Optionally, the terminal further includes: a selection mode providing module configured to provide a selection mode of the region selecting operation, wherein the selection mode includes at least one of a single-row or single-column selection mode, a multi-row or multi-column selection mode, and an irregular closed-curve selection mode.

Optionally, the terminal further includes: a shooting module configured to acquire the capturing object via shooting or tracking, and display the acquired capturing object on the screen of the terminal in an image form.

Optionally, the rapid inputting module includes: a presetting module configured to preset a corresponding relationship between the operation gesture and the inputting manner; a second identification module configured to identify the operation gesture inputted by the user, and determine the inputting manner corresponding to this operation gesture; a memory sharing buffer control module configured to process the data information extracted by the data capturing module and buffer it into a buffer; and an automatic inputting module configured to acquire the data information from the buffer and input it into the target region according to the inputting manner corresponding to the operation gesture.

Optionally, the automatic inputting module includes: a data processing module configured to acquire the data information from the buffer, and process the data information into one-dimensional data or two-dimensional data according to the inputting manner corresponding to the operation gesture; an automatic inputting script control module configured to send a control instruction to a virtual keyboard module, so as to control the virtual keyboard module to send an operation instruction for moving a mouse focus to the target region; and the virtual keyboard module configured to send the operation instruction and send a paste instruction for pasting the data processed by the data processing module to the target region.

Optionally, the automatic inputting script control module is configured to, when the data information is processed by the data processing module into the two-dimensional data and every time one element in the two-dimensional data is inputted by the virtual keyboard module, send the control instruction to the virtual keyboard module so as to indicate the virtual keyboard module to move the mouse focus to a next target region, until all elements in the two-dimensional data are inputted.

Optionally, the capturing object and the target region are displayed on the same display screen of the terminal.

According to another aspect of the present disclosure, there is provided a method for inputting data, including: extracting data information from a designated capturing object; identifying an operation gesture of a user, and inputting the extracted data information into a target region according to an inputting manner corresponding to the identified operation gesture, wherein the inputting manner includes an application program to be inputted and an input format.

Optionally, the extracting data information from the designated capturing object includes: detecting a region selecting operation with respect to a picture displayed on a screen of the terminal so as to acquire the selected capturing object; performing an image processing on the selected capturing object to obtain a valid picture region; and identifying the valid picture region to extract the data information.

Optionally, before extracting data information from the designated capturing object, the method further includes: acquiring the capturing object via shooting or tracking, and displaying the acquired capturing object on the screen of the terminal in an image form.

Optionally, the identifying the operation gesture of the user, and inputting the extracted data information into the target region according to the inputting manner corresponding to the identified operation gesture includes: identifying an operation gesture inputted by the user, and determining an inputting manner corresponding to the operation gesture according to the preset corresponding relationship between the operation gesture and the inputting manner; processing the identified data information and buffering it into a buffer; and acquiring the data information from the buffer and inputting it into the target region according to the inputting manner corresponding to the operation gesture.

Optionally, the acquiring the data information from the buffer and inputting it into the target region according to the inputting manner corresponding to the operation gesture includes: step 1, acquiring the data information from the buffer, and processing the data information into one-dimensional data or two-dimensional data according to the inputting manner corresponding to the operation gesture; step 2, simulating a keyboard to send an operation instruction for moving a mouse focus to the target region; and step 3, simulating the keyboard to send a paste instruction for pasting the processed data to the target region.

Optionally, when the data information is processed into the two-dimensional data, every time one element in the two-dimensional data is inputted, returning to the step 2 to move the mouse focus to a next target region, until all elements in the two-dimensional data are inputted.

Optionally, the capturing object and the target region are displayed on the same display screen of the terminal.

Through the present disclosure, data information is extracted from a capturing object, and then the extracted data information is automatically inputted into a target region according to an inputting manner corresponding to the operation gesture of the user, which solves the problems of time and energy waste as well as low accuracy existing in manually inputting outside computer-unidentifiable information, enables information to be quickly and accurately inputted, and improves the user experience.

This section provides a summary of various implementations or examples of the technology described in the disclosure, and is not a comprehensive disclosure of the full scope or all features of the disclosed technology.

### BRIEF DESCRIPTION OF THE DRAWINGS

The drawings illustrated herein are intended to provide further understanding of the present disclosure, and constitute a part of the present application. Exemplary embodiments and explanations of the present disclosure herein are only for explanation of the present disclosure, but are not intended to limit the present disclosure. In the drawings:

FIG. 1 is a structural schematic diagram of a terminal according to embodiments of the present disclosure;

FIG. 2 is a structural schematic diagram of an optional implementation manner of a data capturing module 10 in the embodiments of the present disclosure;

FIG. 3 is a structural schematic diagram of an optional implementation manner of a rapid inputting module 20 in the optional embodiments of the present disclosure;

FIG. 4 is a schematic diagram of selecting a capturing object in the embodiments of the present disclosure;

FIG. 5 is an illustrative diagram of a data information inputting operation in the embodiments of the present disclosure;

FIG. 6 is another illustrative diagram of the data information inputting operation in the embodiments of the present disclosure;

FIG. 7 is a flow chart of a method for inputting data, according to embodiments of the present disclosure;

FIG. 8 is a flow chart of inputting character string data, according to a first embodiment of the present disclosure;

FIG. 9 is a schematic diagram of inputting a table, according to a second embodiment of the present disclosure;

FIG. 10 is a flow chart of inputting a table, according to the second embodiment of the present disclosure;

FIG. 11 is a flow chart of inputting a telephone number, according to a third embodiment of the present disclosure; and

FIG. 12 is a flow chart of automatically inputting a score, according to a fourth embodiment of the present disclosure.

### DETAILED DESCRIPTION

Hereinafter, the present disclosure would be described in details by referring to the drawings in combination with embodiments. It should be illustrated that the embodiments in the present application and the features in the embodiments can be mutually combined if there is no conflict.

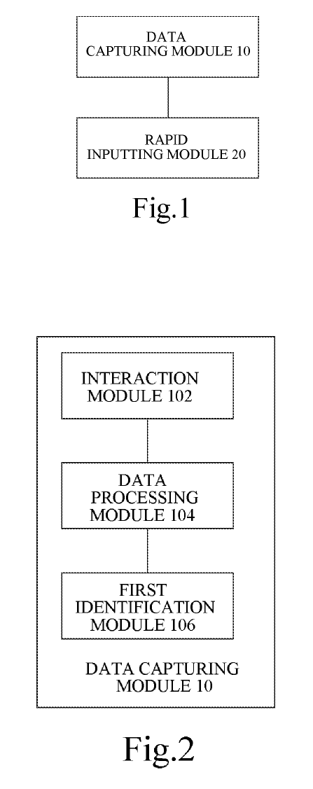

FIG. 1 is a structural schematic diagram of a terminal according to embodiments of the present disclosure. As shown in FIG. 1, the terminal mainly includes: a data capturing module 10 and a rapid inputting module 20. The data capturing module 10 is used for extracting data information from a capturing object. The rapid inputting module 20 is used for identifying an operation gesture of a user, and inputting the extracted data information into a target region according to an inputting manner corresponding to the identified operation gesture. The inputting manner includes an application program to be inputted and an input format.

In the above terminal provided by the present embodiment, the data information is extracted from the capturing object via the data capturing module 10, then the data information is automatically inputted into the target region via the rapid inputting module 20. In this way, inconvenience brought out by the manual inputting can be avoided, and the user experience is improved.

In an optional implementation manner of the embodiments of the present disclosure, as shown in FIG. 2, the data capturing module 10 may include: an interaction module 102 used for detecting a region selecting operation with respect to a picture displayed on a screen of the terminal so as to acquire the capturing object; a data processing module 104 used for performing an image processing on the capturing object to obtain a valid picture region; and a first identification module 106 used for identifying the valid picture region so as to extract the data information.

In an optional implementation manner of the embodiments of the present disclosure, the first identification module 106 may be an Optical Character Recognition (OCR) module. The OCR recognition is performed on the capturing object via the OCR module, thereby identifiable character string data can be obtained.

In an optional implementation manner of the embodiments of the present disclosure, the capturing object may be a picture, a photo shot by a camera, effective information identified from a focus frame by the camera without shooting, or the like. Thereby, the image displayed on the screen of the terminal may be static or dynamic. In this optional implementation manner, the terminal may further include: a shooting module used for acquiring the capturing object via shooting or tracking, and displaying the acquired capturing object on the screen of the terminal in an image form. That is, the user may select a picture region needing inputting when shooting outside things via a periphery device (such as a built-in camera) of the user terminal; or may browse a picture after shooting the picture (or acquiring the picture via network or other channel), and then select the picture region needing inputting.

In an optional implementation manner, the data capturing module 10 may be combined with the shooting module, i.e., the shooting module has the data capturing function (such as the OCR function) and the shooting function at the same time (such as a camera having the OCR function); or the data capturing module 10 may further have a picture browsing function, i.e., the function of extracting data when providing the picture browsing, such as a picture browsing module having the OCR function, which is not limited by the embodiments of the present disclosure.

Through the above optional implementation manners of the embodiments of the present disclosure, the picture region selected by the user is acquired via the interaction module 102, and the data information of the picture region selected by the user is extracted. In this way, the picture region selected by the user can be conveniently and quickly inputted into the terminal, and the user experience is improved.

In an optional implementation manner of the embodiments of the present disclosure, to facilitate the selection by the user, the terminal may also provide a selection mode providing module, i.e., a selection module for providing the region selecting operation. The selection mode includes at least one of a single-row or single-column selection mode, a multi-row or multi-column selection mode, and an irregular closed-curve selection mode.

For example, the single-row or single-column mode refers to selecting picture information of a certain straight line. If the user selects the single-row or single-column mode, when performing the region selecting operation, the user performs a touch selecting operation on a region needing to be identified, i.e., using a start touch as a start point, then performing a straight-line touching operation in an arbitrary direction, and enlarging a range of the selected region gradually, until the touch is completed. While performing the selection by the user, the user terminal may provide a corresponding box for indicating the illustrated range. After the complete of the touch, the picture within the selected range is cut out, and then is transferred to a background image processing module.

The multi-row or multi-column mode refers to selecting picture information within a certain rectangular box. If the user selects the multi-row or multi-column mode, when performing the region selecting operation by the user, the touch selecting procedure is performed on two straight lines, traces of such two straight lines are continuous, the first straight line is a diagonal line of the rectangular, and the second straight line is a certain side of the rectangular, thereby one rectangular may be determined. Meanwhile, a rectangular display box is displayed for indicating the selected region, and the cut-out picture is transferred to the background image processing module.

In the case where optical data of the picture cannot be depicted by the rectangular, the embodiments of the present disclosure also provide a manner of drawing a closed curve for extracting corresponding picture data. By using the closed-curve mode, the touch extraction may be performed by starting at any position on an edge of the optical character string, then continuously drawing along the edge, and finally returning to the start point, so as to constitute a closed curve. Then, the picture within the closed-curve region is extracted and transferred to the background image processing module to be processed.

Through the optional implementation manner, multiple selection manners for picture regions may be provided for the user, so as to facilitate the selection by the user.

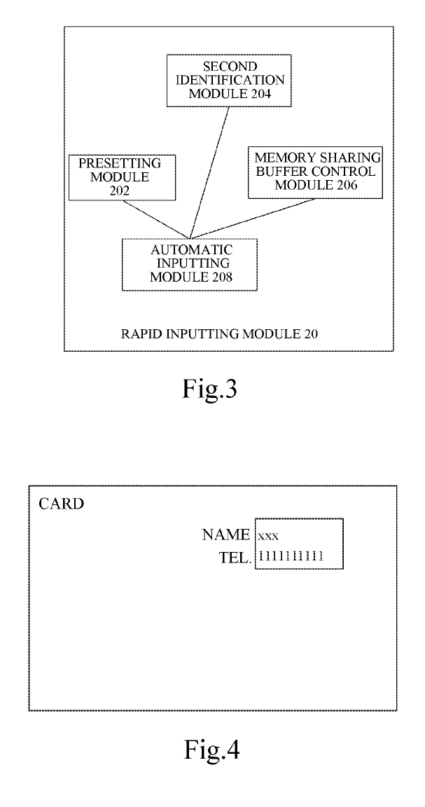

In an optional implementation manner of the embodiments of the present disclosure, as shown in FIG. 3, the rapid inputting module 20 may include: a presetting module 202 used for presetting a corresponding relationship between the operation gesture and the inputting manner; a second identification module 204 used for identifying the operation gesture inputted by the user, and determining the inputting manner corresponding to this operation gesture; a memory sharing buffer control module 206 used for processing the data information extracted by the data capturing module 10 and buffering it into a buffer; and an automatic inputting module 208 used for acquiring the data information from the buffer and inputting it into the target region according to the inputting manner corresponding to the operation gesture. In this optional implementation manner, the data information extracted by the data capturing module 10 is buffered into the buffer, thereby the collected data information can be copied across processes.

In another optional implementation manner, if the extracted data information is character strings, and contains a plurality of character strings, when buffering the character strings into the memory sharing buffer, the memory sharing buffer control module 206 adds a special character after individual character strings so as to separate individual character strings. Through the optional implementation manner, the identified multiple character strings can be separated, such that it is possible to select to only input one of the character strings, or input individual character strings into different text regions.

In another optional implementation manner, the automatic inputting module 208 may include: a data processing module used for acquiring the data information from the buffer, and processing the data information into one-dimensional data or two-dimensional data according to the inputting manner corresponding to the operation gesture; an automatic inputting script control module used for sending a control instruction to a virtual keyboard module, so as to control the virtual keyboard module to send an operation instruction for moving a mouse focus to the target region; and the virtual keyboard module used for sending the operation instruction and sending a paste instruction for pasting the data processed by the data processing module to the target region.

In an optional implementation manner of the embodiments of the present disclosure, for the two-dimensional data, the automatic inputting script control module is used for, every time one element in the two-dimensional data is inputted by the virtual keyboard module, sending the control instruction to the virtual keyboard module so as to indicate the virtual keyboard module to move the mouse focus to a next target region, until all elements in the two-dimensional data are inputted. Through this implementation manner, the identified multiple character strings can be respectively inputted into different text regions, thereby it is possible to achieve a table inputting, i.e., different character strings are inputted into different tables.

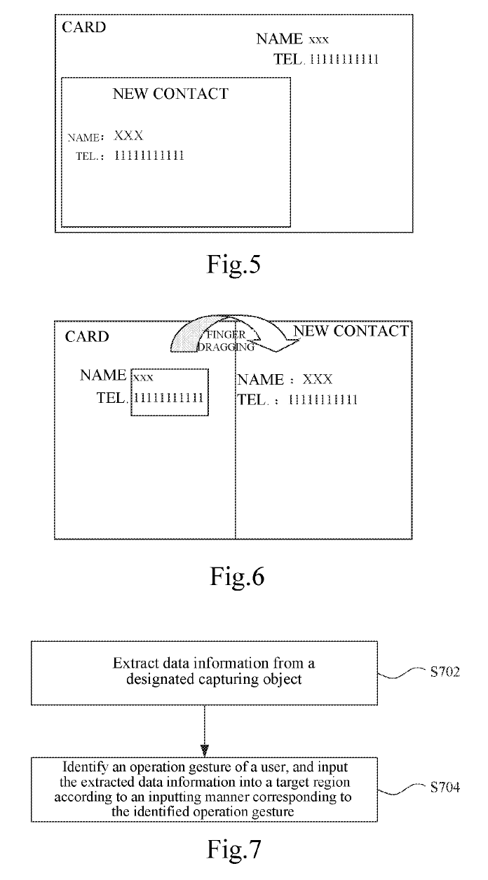

In the embodiments of the present disclosure, the operation gesture may include clicking or dragging. For example, as to a card picture shown in FIG. 4, the user needs to input information of a name and a telephone number, then the user may select a picture region (as shown in a box in FIG. 4) containing the name and the telephone number in the picture, and then the user clicks or drags the selected picture region. After that, the terminal determines that it is necessary to input the contact information according to the preset corresponding relationship between the operation gesture and the inputting manner, extracts the name and the telephone number in the picture region, and pastes them into an address book as a new contact, as shown in FIG. 5.

In an optional implementation manner of the embodiments of the present disclosure, the capturing object and the target region are displayed on the same display screen of the terminal. The user may input an operation of dragging the selected picture region to another application program window displayed on the same screen (two or more than two program windows may be displayed on the display screen), then the terminal responds to the operation of the user, the data capturing module 10 extracts the data information (i.e., the name and telephone number information) of the capturing object (i.e., the selected picture region), and the rapid inputting module 20 inputs the extracted data information into another application program. For example, in FIG. 6, the user selects a picture region containing the name and the telephone number (as shown in a box in FIG. 6) in the picture, then the user drags the selected picture region to a new contact window in the address book, in response to this operation of the user, the data capturing module 10 extracts the data information (i.e., the name and telephone number information) of the capturing object (i.e., the selected picture region), and the rapid inputting module 20 inputs the extracted data information (i.e., the name and telephone number information) into a text box corresponding to the new contact.

According to the embodiments of the present disclosure, a method for inputting data is also provided. The method may be realized by the above user terminal.

FIG. 7 is a flow chart of a method for inputting data, according to embodiments of the present disclosure. As shown in FIG. 7, the method mainly includes the following steps (step S702-step S704).

In step S702, data information is extracted from a designated capturing object.

Alternatively, the capturing object may be a picture, a photo shot by a camera, effective information identified from a focus frame by the camera without shooting, or the like. Thereby, the image displayed on a screen of the terminal may be static or dynamic. In this optional implementation manner, the method may further include: acquiring the capturing object via shooting or tracking, and displaying the acquired capturing object on the screen of the terminal in an image form. That is, the user may select a picture region needing inputting when shooting outside things via a periphery device (such as a built-in camera) of the user terminal; or may browse a picture after shooting the picture (or acquiring the picture via network or other channel), and then select the picture region needing inputting.

In an optional implementation manner of the embodiments of the present disclosure, step S702 may include the following steps: detecting a region selecting operation with respect to a picture displayed on a screen of the terminal so as to acquire the selected capturing object; performing an image processing on the capturing object to obtain a valid picture region; and identifying the valid picture region to extract the data information. For example, the OCR technology may be adopted to identify the picture region so as to acquire character string data of the picture region.

In an optional implementation manner of the embodiments of the present disclosure, to facilitate the selection by the user, when performing the region selecting operation, the selection may be performed according to the selection mode of the terminal. The selection mode includes at least one of a single-row or single-column selection mode, a multi-row or multi-column selection mode, and an irregular closed-curve selection mode.

For example, the single-row or single-column mode refers to selecting picture information of a certain straight line. If the user selects the single-row or single-column mode, when performing the region selecting operation, the user performs a touch selecting operation on a region needing to be identified, i.e., using a start touch as a start point, then performing a straight-line touching operation in an arbitrary direction, and enlarging a range of the selected region gradually, until the touch is completed. While performing the selection by the user, the user terminal may provide a corresponding box for indicating the illustrated range. After the complete of the touch, the picture within the selected range is cut out, and then is transferred to a background image processing module.

The multi-row or multi-column mode refers to selecting picture information within a certain rectangular box. If the user selects the multi-row or multi-column mode, when performing the region selecting operation by the user, the touch selecting procedure is performed on two straight lines, traces of such two straight lines are continuous, the first straight line is a diagonal line of the rectangular, and the second straight line is a certain side of the rectangular, thereby one rectangular may be determined. Meanwhile, a rectangular display box is displayed for indicating the selected region, and the cut-out picture is transferred to the background image processing module.

In the case where optical data of the picture cannot be depicted by the rectangular, the embodiments of the present disclosure also provide a manner of drawing a closed curve for extracting corresponding picture data. By using the closed-curve mode, the touch extraction may be performed by starting at any position on an edge of the optical character string, then continuously drawing along the edge, and finally returning to the start point, so as to constitute a closed curve. Then, the picture within the closed-curve region is extracted and transferred to the background image processing module to be processed.

Through the optional implementation manner, multiple selection modes for picture regions may be provided for the user, so as to facilitate the selection by the user.

In step S704, an operation gesture of a user is identified, and the extracted data information is inputted into a target region according to an inputting manner corresponding to the identified operation gesture, the inputting manner including an application program to be inputted and an input format.

Alternatively, step S704 may include the following steps: identifying an operation gesture inputted by the user, and determining an inputting manner corresponding to the operation gesture according to the preset corresponding relationship between the operation gesture and the inputting manner; processing the identified data information and buffering it into a buffer; and acquiring the data information from the buffer and inputting it into the target region according to the inputting manner corresponding to the operation gesture. In this optional implementation manner, the data information extracted by the data capturing module 10 is buffered into the buffer, thereby the collected data information can be copied across processes.

In another optional implementation manner, if the extracted data information is character strings, and contains a plurality of character strings, when buffering the character strings into the memory sharing buffer, a special character is added after individual character strings so as to separate individual character strings. Through the optional implementation manner, the identified multiple character strings can be separated, such that it is possible to select to only input one of the character strings, or input individual character strings into different text regions.

In another optional implementation manner, the acquiring the data information from the buffer and inputting it into the target region according to the inputting manner corresponding to the operation gesture may include: step 1, acquiring the data information from the buffer, and processing the data information into one-dimensional data or two-dimensional data according to the inputting manner corresponding to the operation gesture; step 2, simulating a keyboard to send an operation instruction for moving a mouse focus to the target region; and step 3, simulating the keyboard to send a paste instruction for pasting the processed data to the target region. In this optional implementation manner, when simulating the keyboard to send the operation instruction, it is possible to send a control instruction to a virtual keyboard module of the terminal and instruct the virtual keyboard module to send the operation instruction; while in step 3, it is possible to send the paste instruction by the virtual keyboard module to the controller to achieve the paste operation of the data.

In an optional implementation manner of the embodiments of the present disclosure, for the two-dimensional data, every time one element in the two-dimensional data is inputted, the procedure returns to step 2 to move the mouse focus to a next target region, until all elements in the two-dimensional data are inputted.

In an optional implementation manner of the embodiments of the present disclosure, the above capturing object and the target region are displayed on the same display screen of the terminal. The user may input an operation of dragging the selected picture region to another application program window displayed on the same screen (two or more than two program windows may be displayed on the display screen), then the terminal responds to the operation of the user, extracts the data information (i.e., the name and telephone number information) of the capturing object (i.e., the selected picture region), and inputs the extracted data information into another application program. For example, in FIG. 6, the user selects a picture region containing the name and the telephone number (as shown in a box in FIG. 6) in the picture, then the user drags the selected picture region to a new contact window in the address book, in response to this operation of the user, the data information (i.e., the name and telephone number information) of the capturing object (i.e., the selected picture region) is extracted, and the extracted data information (i.e., the name and telephone number information) is inputted into a text box corresponding to the new contact.

Through the above method provided by the embodiments of the present disclosure, by extracting data information from the capturing object, and then automatically inputting the data information into the target region, inconvenience brought out by the manual inputting can be avoided, and the user experience is improved.

Hereinafter, the technical solutions provided by the embodiments of the present disclosure are described by specific embodiments.

### First Embodiment

In the embodiments of the present disclosure, the user terminal achieves full-screen display for the left and right windows via a one-into-two split-screen technology, such that two application programs are displayed on the screen of the user terminal at the same time. The computer-unidentifiable picture data is extracted from one of the split-screens, and changed into computer-identifiable character string data via the OCR technology, then the data is inputted into the other split-screen via touching and dragging, so as to achieve the effect of copying and pasting data like in one application program.

In the present embodiment, by utilizing the split-screen technology provided by the user terminal, such as a large smart phone or PAD, a multi-window display function is provided for the user terminal, and a multi-mode selection to the optical data region is achieved by utilizing touching operation of the terminal. After preprocessing the image, the OCR recognition is performed on the image to convert optical data into computer-identifiable character string data, then the data is dragged to an editable input box in another window, and the data is displayed in the input box via a clipboard and the virtual keyboard technology, so as to achieve split-screen inputting data.

In the present embodiment, the split-screen refers to the one-into-two screen, in which the screen of the user terminal is divided into two regions. Each region may display one application program and each application program occupies the whole split-screen space. The effect thereof is similar with full-screen display of left and right split-screens of WIN7.

In the present embodiment, a camera or a picture browsing module is opened in one split-screen, the picture is displayed on the screen, one piece of picture region is selected and extracted via the touch operation, the image preprocessing and OCR technology are used to identify data in the region as the character string, and the character string is dragged to an editable box of the application program in the other split-screen. The region selection may be a single-row/single-column selection and a multi-row/multi-column selection for rectangular, or may be a polygon selection for non-rectangular.

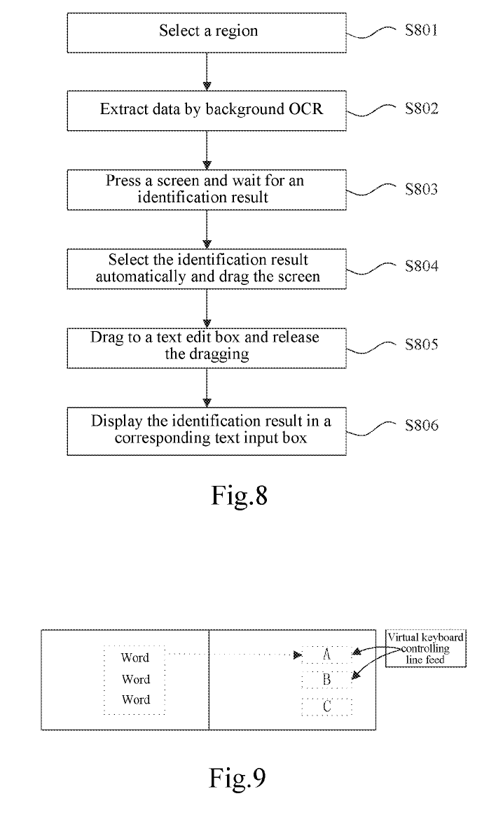

FIG. 8 is a flow chart of inputting character strings, in which the character strings are identified from a picture displayed in one split-screen, and then the character strings are copied to the application program displayed in the other split-screen. As shown in FIG. 8, in the present embodiment, the character string inputting mainly includes the following step S801-step S806.

In step S801, a touch selection performed on an optical region needing to be recognized is detected. In the embodiment, the single-row/single-column selection and the multi-row/multi-column selection for rectangular may be performed, or the polygon selection for non-rectangular may be performed. The purpose is identifying the optical character in this region into a character string. After performing the region selection by the user, a boundary line of the selected region may appear to prompt the selected region.

In step S802, a picture cutting is performed on the selected region. First, an image preprocessing is performed at the background, then an OCR recognition engine is called to perform the optical recognition.

In step S803, during the OCR recognition at the background, the user presses the screen at the same time to wait the recognition result. Upon the recognition result comes out, a bubbling prompt will appear, and the recognition result is displayed in the prompt box; then the recognition result is put by the background into a clipboard which acts as a sharing region of inter-process communication.

In step S804, a bubbling prompt box for placing the recognition result may move with touching and dragging by the finger.

In step S805, the prompt box is dragged to an upper side of an editable box needing to be inputted, the touching is released, and the focus is positioned to a text edit area so as to display the data on this area.

In step S806, the data is extracted from a clipboard in the sharing buffer, and the data is copied to the text edit area having the focus region via the virtual keyboard.

### Second Embodiment

In the present embodiment, still taking the one-into-two split-screen display as an example, illustrations are given for explaining inputting the picture information displayed in one split-screen into a table in the other split-screen.

In the present embodiment, the table may be a table divided by lines, or may be irregular multiple lines of character string array without a middle line for division, or may be a column of data in a certain kind of controls, in which character string arrays may be obtained after being divided and identified.

In the present embodiment, as shown in FIG. 9, a character string array is extracted from a picture in one split-screen. In another application program, a first text edit box needing to be inputted is set, and then the identified data are inputted in turn.

Since the controls are a group of same type of editable control class, each control may be arranged in column/row, and the change of the text edit focus may be achieved via a certain keyboard operation. For example, as to a certain column of controls, the focus is located at an editable box A, and by pressing “ENTER” on the keyboard, the focus directly goes to an editable box B.

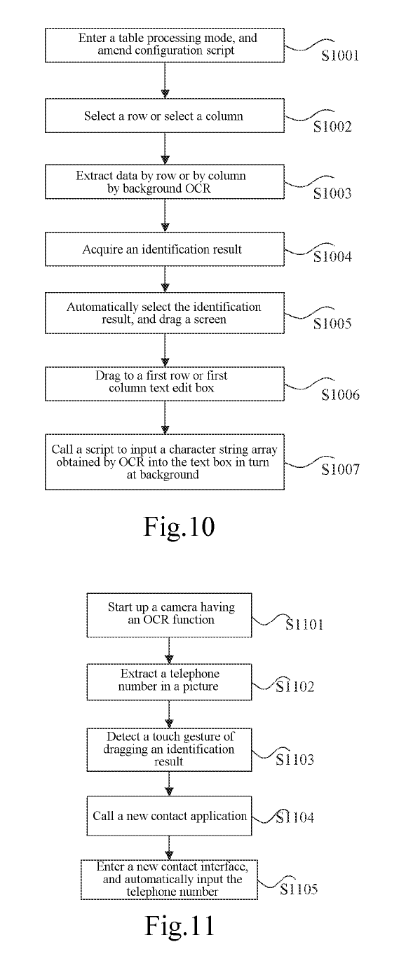

FIG. 10 is a flow chart of inputting a table in the present embodiment. As shown in FIG. 10, the flow mainly includes the following step S1001-step S1007.

In step S1001, a table processing mode is selected, a script configuration file is amended, and the editable box is altered to change a focus control key.

In step S1002, a full column/row selection or a partial column/row selection is performed on the picture, the selection result is prompted via a wireframe, and an automatic division of row and column is realized according to a blank or a line among characters.

In step S1003, an image preprocessing and an OCR recognition are performed respectively on each optical character string region in the selected region, and the recognition result is displayed nearby.

In step S1004, all the recognition results are acquired. In the present embodiment, it is possible to select all the character strings to drag, or it is possible to drag a single recognized character string.

In step S1005, a dragging operation is performed.

In step S1006, a focus is set at a first text edit box corresponding to a position at which the dragging is released, as a first inputting data region.

In step S1007, a script is called to copy the first data in the character string array to the editable text box having the focus, then the focus of the text edit box is changed via the virtual keyboard, and then a similar operation is performed, until the data are completely inputted.

It can be seen from the above embodiments, in the present embodiment, two application programs are displayed by using the one-into-two split-screen of the smart phone. In one of the split-screens, a camera peripheral device having an OCR recognition or a picture processing application is utilized, and an interaction operation of the touch screen is used, so as to obtain a rough effective mode recognition region, then an effective mode recognition region is obtained via the image processing technology, after that, computer-unidentifiable information in the effective region is changed into computer information data via the OCR technology, then the information is dragged to another application program via touching and dragging, and then the smart inputting of the data is achieved via technology such as the clipboard and the virtual keyboard technology. The inputting system, in combination with utility, provides a method for acquiring information simply and conveniently for the user, and has wide application scenes.

### Third Embodiment

In the technical solutions provided by the embodiments of the present disclosure, the data may be dragged to the text edit box in other split-screen interface when the screen is split, or the data may be inputted into other position having requirements via the gesture operation when the screen is not split, and a corresponding application program is called automatically.

In the present embodiment, during the usage of the camera having the OCR recognition, if a telephone number is in the selected picture region, after displaying the OCR recognition, a new contact inputting interface may be called via a certain gesture, and the recognized telephone number is automatically inputted into a corresponding edit box, so as to achieve the purpose of rapid inputting.

FIG. 11 is a flow chart of automatically inputting a telephone number in the present embodiment. As shown in FIG. 11, the flow mainly includes the following step S1101-step S1105.

In step S1101, a camera having an OCR function is started up.

In step S1102, an operation on a telephone number in the selected picture inputted by the user is detected, and the telephone number in the picture is extracted.

In step S1103, a touch gesture of dragging the recognition result is detected.

In step S1104, a new contact application is called.

In step S1105, a new contact interface is entered, and the extracted telephone number is automatically inputted.

### Fourth Embodiment

For users, sometimes it may be required to perform an automatic process on a batch of pictures, such as automatic inputting of test scores. There are many test photos, and the automatic inputting is needed. Since a total score is at a fixed position of the test paper, and is in a red font, it has an obvious feature. At this time, the region selecting operation may be reduced, the red font picture region is directly and quickly acquired, the score is acquired by the OCR recognition technology, and the whole procedure can be executed at the background. Thereby, the technical solutions provided by the embodiments of the present disclosure are utilized directly into the score inputting system, the scores are obtained in batch by calling the OCR picture recognition function, and the automatic inputting of the scores is realized by calling the virtual keyboard module.

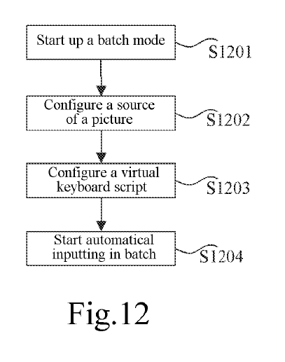

FIG. 12 is a flow chart of inputting scores in the present embodiment. As shown in FIG. 12, the flow mainly includes the following step S1201-step S1204.

In step S1201, a batch recognition mode of a user terminal is started up.

In step S1202, a source of a picture is configured.

In step S1203, a virtual keyboard script is configured.

In step S1204, score information recorded in individual pictures is recognized automatically, and scores are inputted in batch by an automatic inputting script control module.

From the above explanations, it can be seen that in the embodiments of the present disclosure, data information is extracted from a capturing object, and then the extracted data information is automatically inputted into a target region according to an inputting manner corresponding to the operation gesture of the user, which solves the problems of time and energy waste as well as low accuracy existing in manually inputting outside computer-unidentifiable information in the related art, enables information to be quickly and accurately inputted, and improves the user experience.

Apparently, those skilled in the art shall understand that the above-mentioned individual modules and individual steps in the present disclosure may be implemented by using a general purpose computing device, may be integrated in one computing device or distributed on a network which consists of a plurality of computing devices. Alternatively, they can be implemented by using the program code executable by the computing device. Consequently, they can be stored in the storing device and executed by the computing device. Moreover, in some conditions, the illustrated or depicted steps may be executed in an order different from the order described herein, or they are made into individual integrated circuit modules respectively, or a plurality of modules or steps thereof are made into one integrated circuit module. In this way, the present disclosure is not restricted to any particular combination of hardware and software.

The above descriptions are merely preferred embodiments of the present disclosure, but are not intended to limit the present disclosure. For those skilled in the art, the present disclosure may have various alternations and modifications. Any modification, equivalent replacement, improvement and the like, made within the spirit and principle of the present disclosure, shall all fall within the protection scope of the present disclosure.

### INDUSTRIAL APPLICABILITY

In the embodiments of the present disclosure, data information is extracted from a capturing object, and then the extracted data information is automatically inputted into a target region according to an inputting manner corresponding to the operation gesture of the user, which solves the problems of time and energy waste as well as low accuracy existing in manually inputting outside computer-unidentifiable information, enables information to be quickly and accurately inputted, and improves the user experience. Thereby, the present disclosure has the industrial applicability.

1. A terminal, comprising:
a processor; and
a memory for storing instructions executable by the processor;
wherein the processor is configured to:
extract data information from a capturing object;
identify an operation gesture of a user, and input the extracted data information into a target region according to an inputting manner corresponding to the identified operation gesture, wherein the inputting manner comprises an application program to be inputted and an input format.

2. The terminal according to claim 1, wherein the processor is further configured to:
detect a region selecting operation with respect to a picture displayed on a screen of the terminal so as to acquire the capturing object;
perform an image processing on the capturing object to obtain a valid picture region; and
identify the valid picture region so as to extract the data information.

3. The terminal according to claim 2, wherein the processor is further configured to:
provide a selection mode of the region selecting operation, wherein the selection mode comprises at least one of a single-row or single-column selection mode, a multi-row or multi-column selection mode, and an irregular closed-curve selection mode.

4. The terminal according to claim 1, wherein the processor is further configured to:
acquire the capturing object via shooting or tracking, and display the acquired capturing object on the screen of the terminal in an image form.

5. The terminal according to claim 1, wherein the processor is further configured to:
preset a corresponding relationship between the operation gesture and the inputting manner;
identify the operation gesture inputted by the user, and determine the inputting manner corresponding to this operation gesture;
process the extracted data information and buffer it into a buffer; and
acquire the data information from the buffer and input it into the target region according to the inputting manner corresponding to the operation gesture.

6. The terminal according to claim 5, wherein the processor is further configured to:
acquire the data information from the buffer, and process the data information into one-dimensional data or two-dimensional data according to the inputting manner corresponding to the operation gesture;
send an operation instruction for moving a mouse focus to the target region; and
send the operation instruction and send a paste instruction for pasting the processed data to the target region.

7. The terminal according to claim 6, wherein the processor is further configured to, when the data information is processed into the two-dimensional data and every time one element in the two-dimensional data is inputted, move the mouse focus to a next target region, until all elements in the two-dimensional data are inputted.

8. The terminal according to claim 1, wherein the capturing object and the target region are displayed on the same display screen of the terminal.

9. A method for inputting data, comprising:
extracting data information from a designated capturing object;
identifying an operation gesture of a user, and inputting the extracted data information into a target region according to an inputting manner corresponding to the identified operation gesture, wherein the inputting manner comprises an application program to be inputted and an input format.

10. The method according to claim 9, wherein the extracting data information from the designated capturing object comprises:
detecting a region selecting operation with respect to a picture displayed on a screen of the terminal so as to acquire the selected capturing object;
performing an image processing on the selected capturing object to obtain a valid picture region; and
identifying the valid picture region to extract the data information.

11. The method according to claim 9, wherein before extracting data information from the designated capturing object, the method further comprises: acquiring the capturing object via shooting or tracking, and displaying the acquired capturing object on the screen of the terminal in an image form.

12. The method according to claim 9, wherein the identifying the operation gesture of the user, and inputting the extracted data information into the target region according to the inputting manner corresponding to the identified operation gesture comprises:
identifying an operation gesture inputted by the user, and determining an inputting manner corresponding to the operation gesture according to the preset corresponding relationship between the operation gesture and the inputting manner;
processing the identified data information and buffering it into a buffer; and
acquiring the data information from the buffer and inputting it into the target region according to the inputting manner corresponding to the operation gesture.

13. The method according to claim 12, wherein the acquiring the data information from the buffer and inputting it into the target region according to the inputting manner corresponding to the operation gesture comprises:
step 1, acquiring the data information from the buffer, and processing the data information into one-dimensional data or two-dimensional data according to the inputting manner corresponding to the operation gesture;
step 2, simulating a keyboard to send an operation instruction for moving a mouse focus to the target region; and
step 3, simulating the keyboard to send a paste instruction for pasting the processed data to the target region.

14. The method according to claim 13, wherein when the data information is processed into the two-dimensional data, every time one element in the two-dimensional data is inputted, returning to the step 2 to move the mouse focus to a next target region, until all elements in the two-dimensional data are inputted.

15. The method according to claim 9, wherein the capturing object and the target region are displayed on the same display screen of the terminal.

16. The terminal according to claim 2, wherein the capturing object and the target region are displayed on the same display screen of the terminal.

17. The terminal according to claim 3, wherein the capturing object and the target region are displayed on the same display screen of the terminal.

18. The terminal according to claim 4, wherein the capturing object and the target region are displayed on the same display screen of the terminal.

19. The terminal according to claim 5, wherein the capturing object and the target region are displayed on the same display screen of the terminal.

20. A computer storage medium, wherein the computer storage medium is stored with a computer-executable instruction, and the computer-executable instruction is configured to:
extract data information from a designated capturing object;
identify an operation gesture of a user, and inputting the extracted data information into a target region according to an inputting manner corresponding to the identified operation gesture, wherein the inputting manner comprises an application program to be inputted and an input format.
